(19) United States
(12) Patent Application Publication
(10) Pub. No.: US 2024/0161635 A1
(43) Pub. Date: May 16, 2024

(54) MECHANISM FOR AVOIDING ENTERING NO-ENTRY AREA

(71) Applicant: Nokia Technolonies Oy, Espoo (FI)

(72) Inventor: Genliang QIU, Qingdao (CN)

(21) Appl. No.: 18/550,226

(22) PCT Filed: Mar. 18, 2021
(86) PCT No.: PCT/CN2021/081614

§ 371 Date: Sep. 12, 2023

(51) Int. Cl. G08G 5/00; G05D 1/229

(52) U.S. Cl. CPC G08G 5/006; G05D 1/2295; G08G 5/0069; G05D 2109/254

(57) ABSTRACT

Embodiments of the present disclosure relate to a method, device, apparatus and computer readable medium for avoiding entering no-entry areas. According to embodiments of the present disclosure, a first device transmits a request to a second device for querying type information regarding a set of areas. The set of areas are adjacent to an area which the first device currently locates. The second device transmits the type information to the first device. The first device determines whether to transmit its real-time position information based on the type information. In this way, it can reduce workload and save power.

### FIELD

Embodiments of the present disclosure generally relate to the field of telecommunication and in particular, to methods, devices, apparatuses and computer readable storage medium for avoiding entering no-entry area.

### BACKGROUND

Unmanned Aerial Vehicle (UAV) is an aircraft without a human pilot aboard. Nowadays, more and more UAVs are used in many areas for different purposes. Sometimes UAVs are not allowed to enter some geo-areas for some purposes.

### SUMMARY

In general, example embodiments of the present disclosure provide a solution for avoiding entering no-entry area.

In a first aspect, there is provided a first device. The first device comprises at least one processor; and at least one memory including computer program codes; the at least one memory and the computer program codes are configured to, with the at least one processor, cause the first device to: transmit, at the first device located in a first area, a request to a second device for querying type information regarding a set of areas which are adjacent to the first area, the type information indicating whether one or more areas in the set of areas is allowed or not allowed to enter; and receive the type information from the second device.

In a second aspect, there is provided a second device. The second device comprises at least one processor; and at least one memory including computer program codes; the at least one memory and the computer program codes are configured to, with the at least one processor, cause the second device to: receive, at the second device and from a first device located in a first area, a request for querying type information regarding a set of areas which are adjacent to the first area, the type information indicating whether one or more areas in the set of areas is allowed or not allowed to enter; and transmit the type information from the second device.

In a third aspect, there is provided a method. The method comprises transmitting, at a first device located in a first area, a request to a second device for querying type information regarding a set of areas which are adjacent to the first area, the type information indicating whether one or more areas in the set of areas is allowed or not allowed to enter; and receiving the type information from the second device.

In a fourth aspect, there is provided a method. The method comprises receiving, at a second device and from a first device located in a first area, a request for querying type information regarding a set of areas which are adjacent to the first area, the type information indicating whether one or more areas in the set of areas is allowed or not allowed to enter; and transmitting the type information from the second device.

In a fifth aspect, there is provided an apparatus. The apparatus comprises means for transmitting, at a first device located in a first area, a request to a second device for querying type information regarding a set of areas which are adjacent to the first area, the type information indicating whether one or more areas in the set of areas is allowed or not allowed to enter; and means for receiving the type information from the second device.

In a sixth aspect, there is provided an apparatus. The apparatus comprises means for receiving, at a second device and from a first device located in a first area, a request for querying type information regarding a set of areas which are adjacent to the first area, the type information indicating whether one or more areas in the set of areas is allowed or not allowed to enter; and means for transmitting the type information from the second device.

In a seventh aspect, there is provided a computer readable medium. The computer readable medium comprises program instructions for causing an apparatus to perform at least the method according to any one of the above third and fourth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling flow according to some example embodiments of the present disclosure;

FIGS. 3A and 3B illustrate schematic diagrams of divided areas according to some example embodiments of the present disclosure, respectively;

FIG. 4 illustrates a flowchart of a method implemented at a first apparatus according to some example embodiments of the present disclosure;

FIG. 5 illustrates a flowchart of a method implemented at a second apparatus according to some example embodiments of the present disclosure;

FIG. 6 illustrates a simplified block diagram of an apparatus that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated and Access Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. The term “terminal device” refers to any end device that may be capable of wireless communication. In the following description, the terms “terminal device”, “terminal”, “user equipment” and “UE” may be used interchangeably.

As mentioned above, sometimes UAVs are not allowed to enter some geo-areas for some purposes. These areas are referred as restricted areas, so how to avoid UAVs entering restricted areas is an urgent problem to resolve. Currently, to avoid UAVs entering restricted areas, UAVs need to send their live positioning information continuously to Unmanned Aerial System Traffic Management UTM. UTM checks if the sent positioning information is within any restricted area boundary, and if yes, UTM instructs UAVs to stop or move away from the restricted area, or take other actions. Since UAVs need to send their live positioning information continuously to UTM, UAVs battery usage time is a big concern, and continuously receiving positioning information from UAVs also increases UTM workload.

In order to solve at least part of the above problems, a solution for avoiding entering no-entry area is needed. According to embodiments of the present disclosure, a first device transmits a request to a second device for querying type information regarding a set of areas. The set of areas are adjacent to an area which the first device currently locates. The second device transmits the type information to the first device. The first device determines whether to transmit its real-time position information to the second device continuously based on the type information. In this way, it can reduce workload and save power.

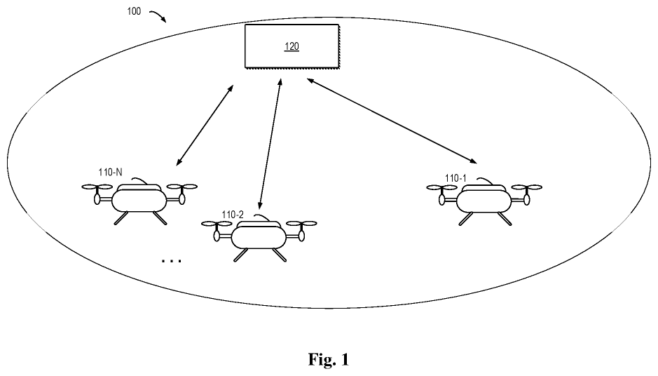

FIG. 1 illustrates a schematic diagram of a communication environment 100 in which embodiments of the present disclosure can be implemented. The communication environment 100, which is a part of a communication network, further comprises a device 110-1, a device 110-2, . . . , a device 110-N, which can be collectively referred to as “device(s) 110.” For example, the device 110 can be unmanned aerial vehicle. The communication environment 100 can comprise a device 120. In some example embodiments, the device 120 can be an unmanned aerial system traffic management (UTM) entity.

The communication environment 100 may comprise any suitable number of devices. In the communication environment 100, the device 110 and the 120 can communicate data and control information to each other.

It is to be understood that the number of devices and their connections shown in FIG. 1 is given for the purpose of illustration without suggesting any limitations. The communication environment 100 may include any suitable number of devices and networks adapted for implementing embodiments of the present disclosure.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

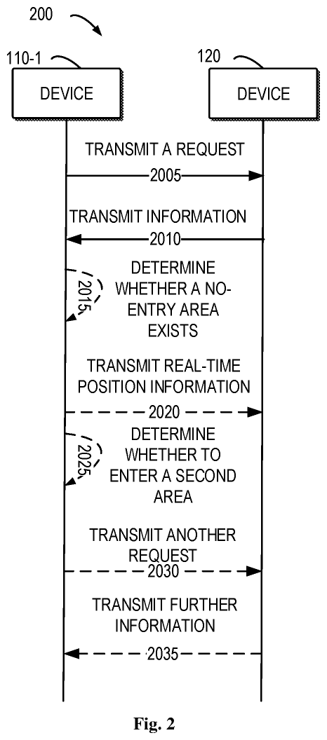

Example embodiments of the present disclosure will be described in detail below with reference to the accompanying drawings. Reference is now made to FIG. 2, which illustrates a signaling flow 200 according to example embodiments of the present disclosure. Only for the purpose of illustrations, the signaling flow 200 involves the device 110-1 and the device 120.

In some example embodiments, a region can be divided into a plurality of areas. For example, the region can be divided into the plurality of areas based on longitude and latitude information. The size of the region can be any proper size. Only as an example, the earth surface can be divided into gridding units (i.e., the plurality of areas) by longitude and latitude with the incremental 0.01°. In other embodiments, the region can be divided into the plurality of areas based on other information, for example, distances. Alternatively or in addition, an area can be also 3 dimensional. In this case, the area can be divided based on longitude, latitude and altitude.

An area in the plurality of areas can be no-entry area or allowed to enter area. The term “no-entry/not allowed to enter area” used herein refers to an area that the UAV or a vehicle can be forbidden flying or entering in. The term “no-fly-zone” used herein can refer to a restricted area or restricted geo-area. The term “no-entry/not allowed to enter area” and the term “no-fly-zone” can be interchangeable. The term “allowed to enter area” used herein refers to an area that the UAV or a vehicle can be permitted to fly or enter in. In some example embodiments, if one area is military objective, this area can be marked as a no-entry area. Alternatively, if one area is sensitive for some reasons, this area can be marked as a no-entry area. In other embodiments, if one area is private, this area can be marked as a no-entry area. As another example, if one area is reserved for a special purpose during a time interval, this area can be marked as a no-entry area. It should be noted one area can be marked as a no-entry area based on any proper reasons. In some example embodiments, the information regarding the plurality of areas can be stored at the device 120 locally. Alternatively, the information regarding the plurality of areas can be stored at a remote storage that the device can access. In some example embodiments, the information regarding the plurality of areas can comprise longitude and latitude information of the plurality of areas. Alternatively or in addition, the information regarding the plurality of areas can comprise identity information of the plurality of areas.

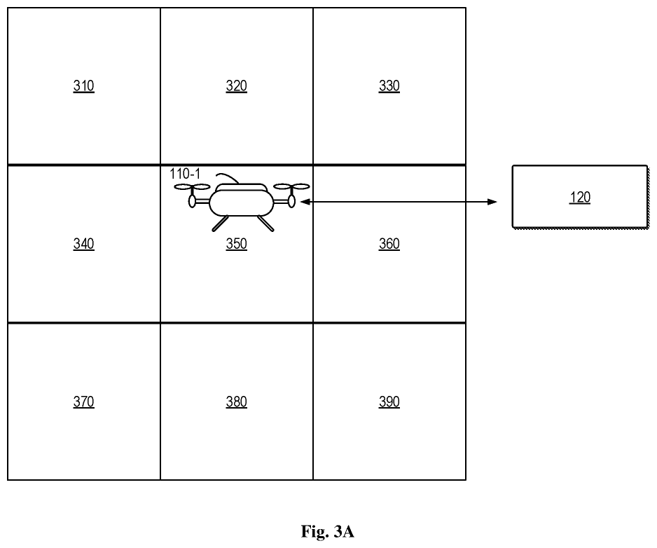

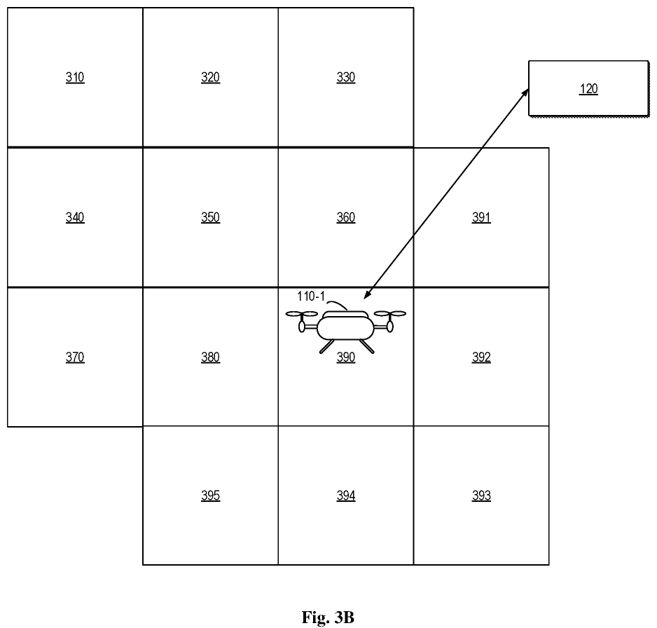

If the device 110-1 enters a first area, the device 110-1 transmits 2005 a request to the device 120 for querying type information regarding a set of areas. The set of areas are adjacent to the first area. The type information indicates whether one area is allowed or not allowed to enter. For example, as shown in FIG. 3A, the device 110-1 enters the area 350. In this case, the device 110-1 can transmit the request to the device 120 for querying type information about the areas 310, 320, 330, 340, 360, 370, 380 and 390.

In some example embodiments, the request can comprise an identity of the first area. In this case, the device 120 can determine the set of areas based on the identity of the first area. Alternatively or in addition, the request can comprise a real-time position of the device 110-1. In this situation, the device 120 can determine the set of areas based on the real-time position of the device 110-1. The device 120 can check whether a no-entry area exists in the set of areas. For example, if an area in the set of areas is military objective, the device 120 can decide that this area is not allowed to enter.

The device 120 transmits 2010 the type information of the set of areas to the device 110-1. In some example embodiments, the type information can indicate each area in the set of areas is allowed or not allowed to enter. Alternatively or in addition, the type information can indicate which area(s) is/are not allowed to enter. In other embodiments, the type information can indicate which area(s) is/are allowed to enter.

In some example embodiments, the device 110-1 can determine 2015 whether a no-entry area exists in the set of areas based on the type information. If a no-entry area exists in the set of areas, the device 110-1 can transmit 2020 real-time position information of the device 110-1 to the device 120. For example, if the type information indicates that at least one area is not allowed to enter, the device 110-1 can transmit its real-time position information to the device 120. By way of example, as shown in FIG. 3A, if the type information indicates that the area 310 is not allowed to enter, the device 110-1 should transmit its real-time position information to the device 120. In other embodiments, if the type information only indicates a subset of areas are allowed to enter (for example, areas 320, 330, and 340), the 110-1 can determine to transmit its real-time position information. The real-time position information can be transmitted periodically.

Alternatively, if the type information indicates all areas in the set of areas are allowed to enter, the device 110-1 can suspend a transmission of its real-time position information. In this case, the device 120 can suspend a reception of real-time position information of the device 110-1. In this way, the device 110-1 can save its battery and the workload at the device 120 can be reduced as well.

In some example embodiments, the device 110-1 can determine 2025 whether to enter a second area. In some example embodiments, if the device 110-1 has moved over a distance which exceeds a threshold distance, the device 110-1 can determine that it enters another area. Alternatively, the device 110-1 can determine whether to enter another area based on its position information. For example, the device 110-1 can determine a first change in longitude of the device 110-1 based on the position information. If the first change exceeds a first threshold, the device 110-1 can determine that the device 110-1 enters a second area. In other example embodiments, the device 110-1 can determine a second change in latitude of the device 110-1 based on the position information. In this case, if the second change exceeds a second threshold, the device 110-1 can determine that the device 110-1 enters a second area. Alternatively, if the device 110-1 can determine a third change in altitude of the device 110-1 based on the position information. In this case, if the third change exceeds a third threshold, the device 110-1 can determine that the device 110-1 enters a second area. The first threshold, the second threshold and the third threshold can be any suitable values. In some example embodiments, the first threshold and the second threshold can depend on the size of one area. Only as an example, if the longitude of the device 110-1 changes 0.01°, the device 110-1 can determine that the device 110-1 enters another area. Alternatively or in addition, if the latitude of the device 110-1 changes 0.01°, the device 110-1 can determine that the device 110-1 enters another area. Generally, a 0.010 change in the longitude can be 1111 m and a 0.010 change in the latitude can be 1113 m.

If the device 110-1 enters the second area, the device 110-1 should transmit 2030 a further request to the second device for querying type information regarding a further set of areas. The further set of areas can be adjacent to the second area. For example, as shown in FIG. 3B, the device 110-1 has moved from the area 350 to the area 390. In this case, the device 110-1 can transmit the further request to the device 120 for querying type information about the areas 350, 360, 391, 380, 392, 393, 394 and 395. Similarly, in some example embodiments, the further request can comprise an identity of the second area. In this case, the device 120 can determine the further set of areas based on the identity of the second area. Alternatively or in addition, the further request can comprise a real-time position of the device 110-1. In this situation, the device 120 can determine the further set of areas based on the real-time position of the device 110-1.

The device 120 can transmit 2035 the further type information of the further set of areas to the device 110-1. In some example embodiments, the further type information can indicate each area in the further set of areas is allowed or not allowed to enter. Alternatively or in addition, the further type information can indicate which area(s) is/are not allowed to enter. In other embodiments, the further type information can indicate which area(s) is/are allowed to enter.

In some example embodiments, the device 110-1 can determine whether a no-entry area exists in the further set of areas based on the type information. If at least one area in the further set of areas is not allowed to enter, the device 110-1 needs to transmit real-time position information of the device 110-1 to the device 120. Alternatively, if all areas in the further set of areas are allowed to enter, the device 110-1 does not need to transmit real-time position information of the device 110-1 to the device 120.

According to embodiments of the present disclosure, the first device does not need to report its live position information continuously to the second device until the first device is approaching to no-fly-zones. In this way, the first device can expand its battery using time greatly, and the second device also can decrease workload dramatically.

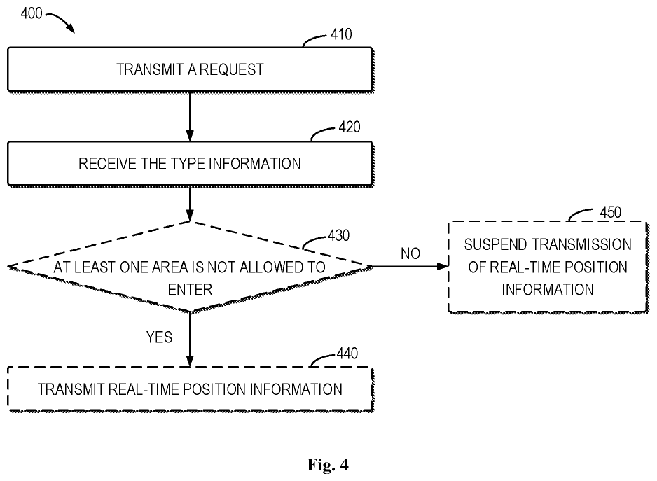

FIG. 4 shows a flowchart of an example method 400 in accordance with some example embodiments of the present disclosure. For the purpose of discussion, the method 400 will be described from the perspective of the device 110-1.

At block 410, if the device 110-1 enters a first area, the device 110-1 transmits a request to the device 120 for querying type information regarding a set of areas. The set of areas are adjacent to the first area. The type information indicates whether one or more areas in the set of areas is allowed or not allowed to enter.

In some example embodiments, the request can comprise an identity of the first area. In this case, the device 120 can determine the set of areas based on the identity of the first area. Alternatively or in addition, the request can comprise a real-time position of the device 110-1. In this situation, the device 120 can determine the set of areas based on the real-time position of the device 110-1.

At block 420, the device 110-1 receives the type information of the set of areas from the device 120. In some example embodiments, the type information can indicate each area in the set of areas is allowed or not allowed to enter. Alternatively or in addition, the type information can indicate which area(s) is/are not allowed to enter. In other embodiments, the type information can indicate which area(s) is/are allowed to enter.

In some example embodiments, at block 430, the device 110-1 can determine whether at least one area in the set of areas is not allowed to enter based on the type information. If at least one area in the set of areas is not allowed to enter, the device 110-1, at block 440, can transmit real-time position information of the device 110-1 to the device 120.

Alternatively, if the type information indicates all areas in the set of areas are allowed to enter, the device 110-1, at block 450, can suspend a transmission of its real-time position information. In this way, the device 110-1 can save its battery and the workload at the device 120 can be reduced as well.

In some example embodiments, the device 110-1 can determine whether to enter a second area. In some example embodiments, if the device 110-1 has moved over a distance which exceeds a threshold distance, the device 110-1 can determine that it enters another area. Alternatively, the device 110-1 can determine whether to enter another area based on its position information. For example, the device 110-1 can determine a first change in longitude of the device 110-1 based on the position information. If the first change exceeds a first threshold, the device 110-1 can determine that the device 110-1 enters a second area. In other example embodiments, the device 110-1 can determine a second change in latitude of the device 110-1 based on the position information. In this case, if the second change exceeds a second threshold, the device 110-1 can determine that the device 110-1 enters a second area. Alternatively, if the device 110-1 can determine a third change in altitude of the device 110-1 based on the position information. In this case, if the third change exceeds a third threshold, the device 110-1 can determine that the device 110-1 enters a second area. The first threshold, the second threshold and the third threshold can be any suitable values. In some example embodiments, the first threshold and the second threshold can depend on the size of one area.

If the device 110-1 enters the second area, the device 110-1 should transmit a further request to the device 120 for querying type information regarding a further set of areas. The further set of areas can be adjacent to the second area. Similarly, in some example embodiments, the further request can comprise an identity of the second area. In this case, the device 120 can determine the further set of areas based on the identity of the second area. Alternatively or in addition, the further request can comprise a real-time position of the device 110-1. In this situation, the device 120 can determine the further set of areas based on the real-time position of the device 110-1.

The device 120 can transmit the further type information of the further set of areas to the device 110-1. In some example embodiments, the further type information can indicate each area in the further set of areas is allowed or not allowed to enter. Alternatively or in addition, the further type information can indicate which area(s) is/are not allowed to enter. In other embodiments, the further type information can indicate which area(s) is/are allowed to enter.

In some example embodiments, the device 110-1 can determine whether a no-entry area exists in the further set of areas based on the type information. If at least one area in the further set of areas is not allowed to enter, the device 110-1 needs to transmit real-time position information of the device 110-1 to the device 120. Alternatively, if all areas in the further set of areas are allowed to enter, the device 110-1 does not need to transmit real-time position information of the device 110-1 to the device 120.

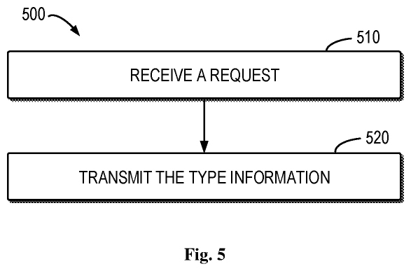

FIG. 5 shows a flowchart of an example method 500 in accordance with some example embodiments of the present disclosure. For the purpose of discussion, the method 500 will be described from the perspective of the device 120.

In some example embodiments, a region can be divided into a plurality of areas. For example, the region can be divided into the plurality of areas based on longitude and latitude information. The size of the region can be any proper size. Only as an example, the earth surface can be divided into gridding units (i.e., the plurality of areas) by longitude and latitude with the incremental 0.01°. In other embodiments, the region can be divided into the plurality of areas based on other information, for example, distances. An area in the plurality of areas can be no-entry area or allowed to enter area. In some example embodiments, if one area is military objective, this area can be marked as a no-entry area. Alternatively, if one area is sensitive for some reasons, this area can be marked as a no-entry area. In other embodiments, if one area is private, this area can be marked as a no-entry area. As another example, if one area is reserved for a special purpose during a time interval, this area can be marked as a no-entry area. It should be noted one area can be marked as a no-entry area based on any proper reasons. In some example embodiments, the information regarding the plurality of areas can be stored at the device 120 locally. Alternatively, the information regarding the plurality of areas can be stored at a remote storage that the device can access. In some example embodiments, the information regarding the plurality of areas can comprise longitude and latitude information of the plurality of areas. Alternatively or in addition, the information regarding the plurality of areas can comprise identity information of the plurality of areas.

At block 510, the device 120 receives a request from the device 110-1 for querying type information regarding a set of areas. The set of areas are adjacent to the first area. The type information indicates whether one area is allowed or not allowed to enter.

In some example embodiments, the request can comprise an identity of the first area. In this case, the device 120 can determine the set of areas based on the identity of the first area. Alternatively or in addition, the request can comprise a real-time position of the device 110-1. In this situation, the device 120 can determine the set of areas based on the real-time position of the device 110-1.

At block 520, the device 120 transmits the type information of the set of areas to the device 110-1. In some example embodiments, the type information can indicate each area in the set of areas is allowed or not allowed to enter. Alternatively or in addition, the type information can indicate which area(s) is/are not allowed to enter. In other embodiments, the type information can indicate which area(s) is/are allowed to enter.

In some example embodiments, if at least one area in the set of areas is not allowed to enter, the device 120 can receive real-time position information of the device 110-1 from the device 110-1. Alternatively, if the type information indicates all areas in the set of areas are allowed to enter, the device 120 can suspend a reception of real-time position information from the device 110-1.

If the device 110-1 enters the second area, the device 120 should receive a further request from the device 110-1 for querying type information regarding a further set of areas. The further set of areas can be adjacent to the second area. Similarly, in some example embodiments, the further request can comprise an identity of the second area. In this case, the device 120 can determine the further set of areas based on the identity of the second area. Alternatively or in addition, the further request can comprise a real-time position of the device 110-1. In this situation, the device 120 can determine the further set of areas based on the real-time position of the device 110-1.

The device 120 can transmit the further type information of the further set of areas to the device 110-1. In some example embodiments, the further type information can indicate each area in the further set of areas is allowed or not allowed to enter. Alternatively or in addition, the further type information can indicate which area(s) is/are not allowed to enter. In other embodiments, the further type information can indicate which area(s) is/are allowed to enter.

In some example embodiments, a first apparatus capable of performing any of the method 400 (for example, the first device) may comprise means for performing the respective operations of the method 400. The means may be implemented in any suitable form. For example, the means may be implemented in a circuitry or software module. The first apparatus may be implemented as or included in the first device. In some example embodiments, the means may comprise at least one processor and at least one memory including computer program code. The at least one memory and computer program code are configured to, with the at least one processor, cause performance of the apparatus.

In some example embodiments, the apparatus comprises means for transmitting, at a first device located in a first area, a request to a second device for querying type information regarding a set of areas which are adjacent to the first area, the type information indicating whether one or more areas in the set of areas is allowed or not allowed to enter; and means for receiving the type information from the second device.

In some example embodiments, the apparatus further comprises means for in accordance with a determination that the type information indicates that at least one area in the set of areas is not allowed to enter, transmitting to the second device real-time position information of the first device.

In some example embodiments, the apparatus further comprises means for in accordance with a determination that the type information indicates that the set of areas is allowed to enter, suspending a transmission of real-time position information of the first device to the second device.

In some example embodiments, the apparatus further comprises means for in accordance with a determination that the first device enters a second area, transmitting to the second device a further request to the second device for querying type information regarding a further set of areas which are adjacent to the second area; and means for receiving from the second device the type information regarding the further set of areas.

In some example embodiments, the apparatus further comprises means for determining that the first device enters the second area, in accordance with a determination that at least one of the following is fulfilled: a first change in longitude of the first device exceeding a first threshold, a second change in latitude of the first device exceeding a second threshold, or a third change in altitude of the first device exceeding a third threshold.

In some example embodiments, the first device is an unmanned aerial vehicle and the second device is an unmanned aerial system traffic management entity.

In some example embodiments, a second apparatus capable of performing any of the method 500 (for example, the second device) may comprise means for performing the respective operations of the method 500. The means may be implemented in any suitable form. For example, the means may be implemented in a circuitry or software module. The first apparatus may be implemented as or included in the first device. In some example embodiments, the means may comprise at least one processor and at least one memory including computer program code. The at least one memory and computer program code are configured to, with the at least one processor, cause performance of the apparatus.

In some example embodiments, the apparatus comprises means for receiving from a first device located in a first area, a request for querying type information regarding a set of areas which are adjacent to the first area, the type information indicating whether one or more areas in the set of areas is allowed or not allowed to enter; and means for transmitting the type information from the second device.

In some example embodiments, the apparatus further comprises means for in accordance with a determination that the type information indicates that at least one area in the set of areas is not allowed to enter, receiving from the first device real-time position information of the first device.

In some example embodiments, the apparatus further comprises means for in accordance with a determination that the type information indicates that the set of areas is allowed to enter, suspending a reception of real-time position information of the first device from the first device.

In some example embodiments, the apparatus further comprises means for receiving from the first device a further request for querying type information regarding a further set of areas which are adjacent to a second area; and means for transmitting to the first device the type information regarding the further set of areas.

In some example embodiments, the first device is an unmanned aerial vehicle and the second device is an unmanned aerial system traffic management entity.

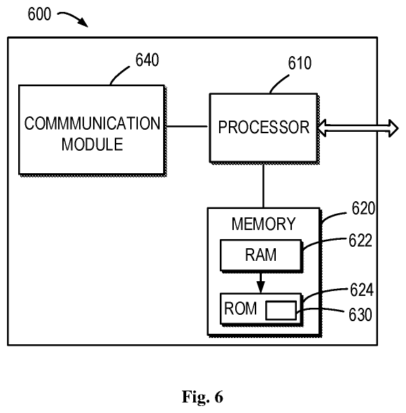

FIG. 6 is a simplified block diagram of a device 600 that is suitable for implementing example embodiments of the present disclosure. The device 600 may be provided to implement a communication device, for example, the device 110 or the device 120 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to assist with communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 630 includes computer executable instructions that are executed by the associated processor 610. The program 630 may be stored in the memory, e.g., ROM 624. The processor 610 may perform any suitable actions and processing by loading the program 630 into the RAM 622.

Example embodiments of the present disclosure may be implemented by means of the program 630 so that the device 600 may perform any process of the disclosure as discussed with reference to FIGS. 2 to 5. The example embodiments of the present disclosure may also be implemented by hardware or by a combination of software and hardware.

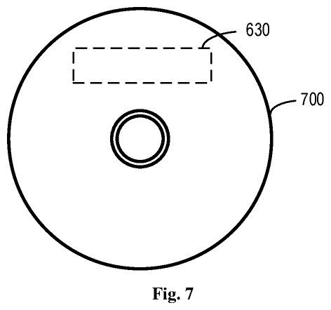

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and other magnetic storage and/or optical storage. FIG. 7 shows an example of the computer readable medium 700 in form of an optical storage disk. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 3 to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-24. (canceled)

25. A first device comprising:
at least one processor;
and at least one memory storing instructions that, when executed by the at least one processor, cause the first device to:
transmit, at the first device located in a first area, a request to a second device for querying type information regarding a set of areas which are adjacent to the first area, the type information indicating whether one or more areas in the set of areas is allowed or not allowed to enter; and
receive the type information from the second device.

26. The first device of claim 25, wherein the instructions, when executed with the at least one processor, further cause the first device to:
in accordance with a determination that the type information indicates that at least one area in the set of areas is not allowed to enter, transmit to the second device real-time position information of the first device.

27. The first device of claim 25, wherein the instructions, when executed with the at least one processor, further cause the first device to:
in accordance with a determination that the type information indicates that the set of areas is allowed to enter, suspend a transmission of real-time position information of the first device to the second device.

28. The first device of claim 25, wherein the instructions, when executed with the at least one processor, further cause the first device to:
in accordance with a determination that the first device enters a second area, transmit to the second device a further request to the second device for querying type information regarding a further set of areas which are adjacent to the second area; and
receive from the second device the type information regarding the further set of areas.

29. The first device of claim 28, wherein the instructions, when executed with the at least one processor, further cause the first device to determine that the first device enters the second area, in accordance with a determination that at least one of the following is fulfilled:
a first change in longitude of the first device exceeds a first threshold,
a second change in latitude of the first device exceeds a second threshold, or
a third change in altitude of the first device exceeds a third threshold.

30. The first device of claim 25, wherein the first device is an unmanned aerial vehicle and the second device is an unmanned aerial system traffic management entity.

31. A second device comprising:
at least one processor; and
at least one memory storing instructions that, when executed by the at least one processor, cause the second device to:
receive, at the second device and from a first device located in a first area, a request for querying type information regarding a set of areas which are adjacent to the first area, the type information indicating whether one or more areas in the set of areas is allowed or not allowed to enter; and transmit the type information from the second device.

32. The second device of claim 31, wherein the instructions, when executed with the at least one processor, further cause the second device to:
in accordance with a determination that the type information indicates that at least one area in the set of areas is not allowed to enter, receive from the first device real-time position information of the first device.

33. The second device of claim 31, wherein the instructions, when executed with the at least one processor, further cause the second device to:
in accordance with a determination that the type information indicates that the set of areas is allowed to enter, suspend a reception of real-time position information of the first device from the first device.

34. The second device of claim 31, wherein the instructions, when executed with the at least one processor, further cause the second device to:
receive from the first device a further request for querying type information regarding a further set of areas which are adjacent to a second area; and
transmit to the first device the type information regarding the further set of areas.

35. The second device of claim 31, wherein the first device is an unmanned aerial vehicle and the second device is an unmanned aerial system traffic management entity.

36. A method, comprising:
transmitting, at a first device located in a first area, a request to a second device for querying type information regarding a set of areas which are adjacent to the first area, the type information indicating whether one or more areas in the set of areas is allowed or not allowed to enter; and
receiving the type information from the second device.

37. The method of claim 36, further comprising:
in accordance with a determination that the type information indicates that at least one area in the set of areas is not allowed to enter, transmitting to the second device real-time position information of the first device.

38. The method of claim 36, further comprising:
in accordance with a determination that the type information indicates that the set of areas is allowed to enter, suspending a transmission of real-time position information of the first device to the second device.

39. The method of claim 36, further comprising:
in accordance with a determination that the first device enters a second area, transmitting to the second device a further request to the second device for querying type information regarding a further set of areas which are adjacent to the second area; and
receiving from the second device the type information regarding the further set of areas.

40. The method of claim 39, further comprising:
determining that the first device enters the second area, in accordance with a determination that at least one of the following is fulfilled:
a first change in longitude of the first device exceeding a first threshold,
a second change in latitude of the first device exceeding a second threshold, or
a third change in altitude of the first device exceeding a third threshold.

41. The method of claim 36, wherein the first device is an unmanned aerial vehicle and the second device is an unmanned aerial system traffic management entity.

42. A method, comprising:
receiving, at a second device and from a first device located in a first area, a request for querying type information regarding a set of areas which are adjacent to the first area, the type information indicating whether one or more areas in the set of areas is allowed or not allowed to enter; and
transmitting the type information from the second device.

43. The method of claim 42, further comprising:
in accordance with a determination that the type information indicates that at least one area in the set of areas is not allowed to enter, receiving from the first device real-time position information of the first device.

44. The method of claim 42, further comprising:
in accordance with a determination that the type information indicates that the set of areas is allowed to enter, suspending a reception of real-time position information of the first device from the first device.
